(19) United States
(12) Patent Application Publication
(10) Pub. No.: US 2024/0165553 A1
(43) Pub. Date: May 23, 2024

(54) DEHUMIDIFICATION AND WATER COLLECTION STRUCTURE

(71) Applicant: CHUNG YUAN CHRISTIAN UNIVERSITY, TAOYUAN CITY (TW)

(72) Inventors: HUEI-CHU WENG, TAOYUAN CITY (TW); CHUN-CHING KUO, TAOYUAN CITY (TW); KUN-DA WU, TAOYUAN CITY (TW); SHENG-WEI LO, TAOYUAN CITY (TW)

(21) Appl. No.: 18/164,902

(22) Filed: Feb. 6, 2023

(30) Foreign Application Priority Data
Nov. 21, 2022 (TW) 111144478

(51) Int. Cl. B01D 53/26; F24F 3/14

(52) U.S. Cl. CPC B01D 53/265; F24F 3/1405; F24F 2003/1446

(57) ABSTRACT

The present invention provides a dehumidification and water collection structure disposed on one side of a temperature control device. The temperature control device is used for converting a temperature to a first temperature. The temperature is greater than the first temperature. The temperature control device includes a temperature conduction device. The temperature conduction device covers one side of the temperature control device. A hydrophilic structure is formed on the surface of the mesh member and used for condensing the vapor in the air. A first side of the mesh member is disposed on the other side of the temperature conduction device. A capillary structure layer is formed between the mesh member and the temperature conduction device. After thermal equilibrium between the air and the mesh member, an air temperature of the air is lowered to a dew temperature and condensing the vapor in the air on the mesh member.

### FIELD OF THE INVENTION

The present invention relates generally to a structure, and particularly to a dehumidification and water collection structure used for collecting or absorbing water.

### BACKGROUND OF THE INVENTION

Humid air facilitates growth of mold and induces health problems. For the sake of good health, people use dehumidification devices to dehumidify. The relative humidity of air is preferably kept between 30% and 50%. High humidity (above 85%) makes people feel uncomfortable, vapor condense, clothes wet, and sleep not smooth and stable. In addition, high humidity also attracts many insects such as silverfishes (tineidae), fleas, and cockroaches.

The operations of the dehumidification device according to the prior art include heating, condensing, and heat exchange. The heating method is performed by hot wind. This method uses electrothermal wires to heat the air by electricity for expanding the air and exhaust the air inside a closed space and thus achieving the effect of dehumidification by hot wind.

The condensing method can be further classified into two types: compressive and electronic types.

Compressive dehumidification: A compressive dehumidifier is formed by a compressor, a heat exchanger, a fan, a water container, a chassis, and a controller. The operating principle starts from the fan blows humid air into the device and passing the heat exchanger. At this moment, the vapor in the air will condense to form water droplets. Then the dried air is exhausted from the device. By repeating the cycle, the indoor humidity will drop.

Most modern air conditioning systems that adopt compressors have dehumidification functions. When the air conditioner is operating, the air is also dehumidified. Contrast to air conditioners exhausting thermal energy outdoors, a dehumidifier will heat up the cold air. Thereby, dehumidification can be done without cooling the air.

In addition, the electronic dehumidification mentioned above is identical to compressive dehumidification except substituting the cooling device by a semiconductor cooling chip for achieving cooling effect.

Nonetheless, for a general compressive dehumidification device, a compressor, a heat exchanger, a fan, a water container, a chassis, and a controller are required. Unfortunately, the compressor will make noise during operation and discomfort users. If it is used in the sleep time, users will feel uncomfortable and suffer from insomnia.

Besides, although this dehumidification device can recycle the condensed water and achieving the purpose of absorbing humidity and collecting water, since a compressor, a heat exchanger, and a controller are required, the process of recycling vapor will be very inconvenient.

Moreover, the dehumidification device described above is bulky and inconvenient for moving. The large volume is caused by the compressor and the heat exchanger. The capacity of recycling the vapor in the air is limited by the capacity of the compressor and the heat exchanger.

Furthermore, the water recycled by a dehumidification device too few to be applied to applications such as desalination, freshwater collection, wastewater recycling (for example, water recycling in the semiconductor industry) except for domestic usage, flower watering, or mopping. The dehumidification device as described above is much insufficient to supply the required amount of recycled water.

Thereby, a huge machine is required for applications such as desalination, freshwater collection, wastewater recycling. Unfortunately, a huge is machine is costly and inconvenient in moving.

Accordingly, how to condense vapor simply and rapidly by disposing the structure on one side of the cooling device and collecting the condensed water rapidly using the capillary action have become the major problem to be solved in the field.

### SUMMARY

An objective of the present invention is to provide a dehumidification and water collection structure. The surface is modified to form a hydrophilic structure on a mesh member. A temperature conduction device receives the low temperature of a temperature control device and lower the temperature of the mesh member to the low temperature of the temperature control device. When the mesh member contacts the humid and hot air, by using the low temperature of the mesh member, the temperature of the humid and hot air can be lowered rapidly to the dew temperature, so that the vapor in the humid and hot air can condense to water and attach to the surface of the mesh member. Then, by using the hydrophilic structure on the surface of the mesh structure, the condensed water can be absorbed and led into a capillary structure layer. Finally, by using capillary action (or capillary action combined with gravity), the condensed water in the capillary structure layer drops downward to the water collection member.

To achieve the above objective, the present invention provides a dehumidification and water collection structure disposed on one side of a temperature control device. The temperature control device is used for converting a temperature to a first temperature. The temperature is greater than the first temperature. The dehumidification and water collection structure includes a temperature conduction device and a mesh member. The temperature conduction device covers one side of the temperature control device. A hydrophilic structure is formed on the surface of the mesh member and used for condensing the vapor in the air. A first side of the mesh member is disposed on the other side of the temperature conduction device. A capillary structure layer is formed between the mesh member and the temperature conduction device. After thermal equilibrium between the air and the mesh member, an air temperature of the air is lowered to a dew temperature and condensing the vapor in the air on the mesh member.

According to an embodiment of the present invention, the temperature control device includes a hot end and a cold end. The hot end is used for generating the temperature, where the temperature is between 30° C. and 100° C. The cold end is disposed on one side of the hot end. The temperature conduction device covers the cold end. A heat dissipation device is disposed on the other side of the hot end and used for dissipating a heat source generated at the hot end.

According to an embodiment of the present invention, a semiconductor layer is further disposed between the hot end and the cold end for converting the temperature to the first temperature.

According to an embodiment of the present invention, the vapor is condensed on a second side of the mesh member. The vapor is absorbed by the hydrophilic structure on the second side and enters the capillary structure layer for condensing to form condensed water in the capillary structure layer. Then the condensed water flows downward by using capillary action (or capillary action combined with gravity).

According to an embodiment of the present invention, the vapor is condensed in the capillary structure layer to form condensed water in the capillary structure layer. Then the condensed water flows downward by using capillary action (or capillary action combined with gravity).

According to an embodiment of the present invention, the first temperature is between 4° C. and 25° C.

According to an embodiment of the present invention, the temperature conduction device adopts metals or nonmetals.

According to an embodiment of the present invention, the mesh member includes a thermal conduction coefficient.

According to an embodiment of the present invention, the thermal conduction coefficient is above 200 W/mK.

According to an embodiment of the present invention, a water collection member is further included and disposed below the heat conduction member and the mesh member.

According to an embodiment of the present invention, the second temperature is between 20° C. and 50° C.

According to an embodiment of the present invention, the air temperature is greater than the second temperature.

### BRIEF DESCRIPTION OF THE DRAWINGS

FIG. 1A shows a schematic diagram of the dehumidification and water collection structure according to an embodiment of the present invention;

FIG. 1B shows a side view of the dehumidification and water collection structure according to an embodiment of the present invention;

FIG. 1C shows an enlarged view of the dehumidification and water collection structure according to an embodiment of the present invention;

FIG. 2A shows an SEM picture of the nanotubes according to an embodiment of the present invention;

FIG. 2B shows an SEM of the nanotubes according to an embodiment of the present invention;

FIG. 2C shows a picture of droplet absorption according to an embodiment of the present invention;

FIG. 2D shows a picture of droplet absorption according to an embodiment of the present invention;

FIG. 3A shows a schematic diagram of the usage status of the dehumidification and water collection structure according to an embodiment of the present invention;

FIG. 3B shows a schematic diagram of the usage status of the dehumidification and water collection structure according to an embodiment of the present invention;

FIG. 3C shows a schematic diagram of the usage status of the dehumidification and water collection structure according to an embodiment of the present invention; and

FIG. 3D shows a schematic diagram of the usage status of the dehumidification and water collection structure according to an embodiment of the present invention.

### DETAILED DESCRIPTION

The dehumidification device according to the prior art requires a compressor, a heat exchanger, a fan, a water container, and a controller. Unfortunately, the compressor will make noise during operation and discomfort users. If it is used in the sleep time, users will feel uncomfortable and suffer from insomnia.

Besides, although this dehumidification device can recycle the condensed water and achieving the purpose of absorbing humidity and collecting water, since a compressor, a heat exchanger, and a controller are required, the process of recycling vapor will be very inconvenient as well as making much noise. Furthermore, a huge machine is required for applications such as desalination, freshwater collection, wastewater recycling. Unfortunately, a huge is machine is costly and inconvenient in moving.

The present invention is disposed on one side of the temperature control device. The temperature control device adjusts the temperature to be lower than the ambient temperature. The temperature conduction device receives the low temperature of the temperature control device and lowers the temperature of the mesh device on the other side to the low temperature of the temperature control device. When the mesh member contacts the humid and hot air, the low temperature of the mesh member can lower the humid and hot air to the dew temperature rapidly and enables the vapor in the humid and hot air to condense to condensed water attaching on the surface of the mesh device. Then, by using a plurality of nanostructures on the surface of the mesh member, the condensed water is absorbed by and led into the capillary structure layer. Finally, by using the capillary action (or capillary action combined with gravity), the condensed water is dripped downward to the water collection member.

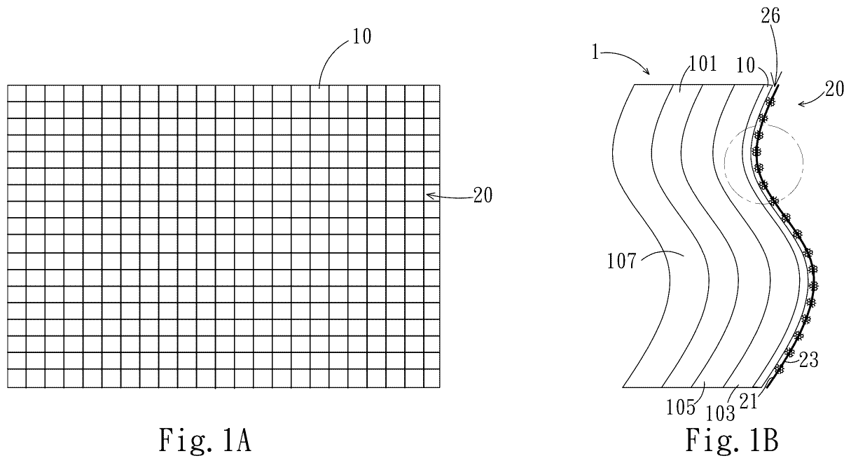

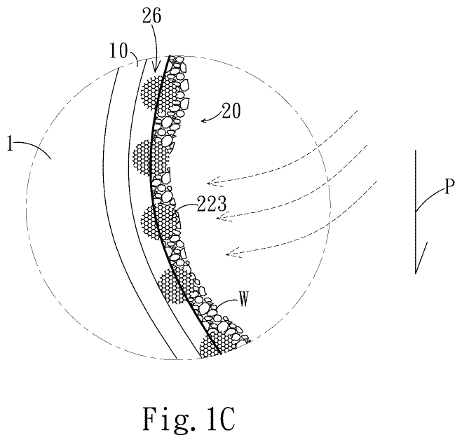

First, please refer to FIG. 1A, which shows a schematic diagram of the dehumidification and water collection structure according to an embodiment of the present invention. As shown in the figure, the dehumidification and water collection structure according to the present embodiment comprises a temperature conduction device 10 and a mesh member 20. The temperature conduction device 10 is disposed on one sides of a temperature control device 1. The temperature conduction device 10 and the temperature control device 1 are used for converting a temperature to a first temperature. The temperature is greater than the first temperature. The first temperature is between 4° C. and 25° C.

According to the present embodiment, temperature control device 1 includes a hot end 101 and a cold end 103. The hot end 101 is used for generating the temperature, where the temperature is between 30° C. and 100° C. The cold end 103 is disposed on one side of the hot end 101. The temperature conduction device 10 covers one side of the cold end 103. A heat dissipation device 107 is disposed on the other side of the hot end 101 and used for dissipating a heat source generated at the hot end 101.

In addition, according to the present embodiment, a semiconductor layer 105 is further disposed between the hot end 101 and the cold end 103 for converting the temperature to the first temperature and enabling the cold end 103 to generate the first temperature.

Next, please refer to FIG. 1B, which shows a side view of the dehumidification and water collection structure according to an embodiment of the present invention, and to FIG. 1C, which shows an enlarged view of the dehumidification and water collection structure according to an embodiment of the present invention. As shown in the figures, a hydrophilic structure is formed on the surface of the mesh member 20 and used for condensing the vapor in the air. A first side 21 of the mesh member 20 is disposed on the other side of the temperature conduction device 10. A plurality of nanostructures 223 are further disposed on the surface of the mesh member 20. The figures according to the present embodiment use the plurality of nanostructures 223 for illustration. Nonetheless, the present invention is not limited to the embodiment.

By using surface modification processes, such as an anodic process, an etching process, or a foaming process, the hydrophilic structure is formed on the surface of the mesh member 20. A capillary structure layer 26 is formed between the hydrophilic structure and the temperature conduction device 10. A second side 23 of the mesh member 20 is used for contacting an air. During the surface modification process of the mesh member 20, the plurality of nanostructures 223 will be further formed on the surface of the mesh member 20. The plurality of nanostructures 223 can facilitate absorption of vapor in the capillary structure layer.

The second temperature is between 4° C. and 25° C. An air temperature of the air is greater than the second temperature.

The temperature conduction device 10 uses metals, for example, copper, aluminum, gold, or silver, or nonmetals, for example, ceramics, graphite sheets, or flexible thermally conductive silica gel, with high thermal conductivity. The mesh member 20 includes a thermal conductivity coefficient, which is above 200 W/mK. Furthermore, if the thermal conductivity coefficient is higher, the thermal conduction management will be more effective for receiving the first temperature of the temperature conduction device 10 more effectively and rapidly.

The heat is transferred from the high-temperature spot to the low-temperature spot. The heat flux is proportional to the gradient of the temperature. For a material with a fixed thickness, if the temperature difference is larger, the temperature gradient will be larger, resulting in larger heat flux. Contrarily, for a material with a fixed temperature difference, if the thickness is larger, the temperature gradient will be smaller, resulting in smaller heat flux.

The thermal conductivity coefficient means the total amount of heat that passes in one second across the opposing sides of a unit cube whose faces are kept so at a temperature difference of 1K or 1° C. The unit is W/mK or W/m° C. The thermal conductivity coefficient depends on the composition, structure, density, water content, and temperature of a material. In general, the thermal conductivity coefficient of a solid is greater than that of a liquid; the thermal conductivity coefficient of a liquid is, in turn, greater than that of a gas.

Next, according to the present embodiment, the anodic process can be used to form the plurality of nanotubes on the surface of the mesh member 20. Alternatively, the etching process or the foaming process can be used to form the plurality of nanostructures 223 (nanoflowers) on the surface of the mesh member 20. For example, perform the anodic process (modify the surface of the mesh member 20 to form the hydrophilic structure) on the mesh member 20 (such as anodic aluminum oxide, AAO). The reason to adopt AAO is owing to its high thermal conductivity coefficient. With this property, after attaching to the temperature control device 1, it is easier to maintain a close temperature with the temperature control device 1. The anodic process will be described in the following. In this example, the mesh member 20 is an aluminum mesh.

First, an aluminum sheet is rinsed by acetone, deionized water and alcohol, and deionized water sequentially. It is immersed in the liquids, respectively, and rinsed by an ultrasonic vibrator for 30 minutes. The purpose is to eliminate the oil and impurities on the surface of the aluminum sheet for avoiding influences on the aluminum sheet during annealing.

Afterwards, a high-temperature furnace is used for annealing at 350° C. for 30 minutes for removing the stress in the aluminum sheet after process. Finally, rinse the aluminum sheet using acetone, deionized water and alcohol, and deionized water again. The aluminum sheet is immersed in the liquids, respectively, and rinsed by an ultrasonic vibrator for 30 minutes for ensuring stability in the subsequent anodic oxidation process.

Next, clamp the aluminum sheet using a fixture for avoiding air in the nanoholes when the nanoholes contact the heat source. The air will cause an extremely large thermal resistance between the aluminum sheet and the heat source and affecting the experimental result. Thereby, the fixture can guarantee that the backside of the aluminum sheet will not react with the electrolyte during the anodic oxidation process.

After finishing the above steps, use a magnetic stirrer to make the concentration distribution of the electrolyte (0.3M H₃PO₄) uniform. In addition, use a constant-temperature water bath to maintain the overall operating temperature at 5° C. Then, place the aluminum sheet at the anode and the 50 mm×50 mm×5 mm aluminum mesh at the cathode. Connect them to a DC power supply and immerse them to the above electrolyte. Apply different operating voltages at different operating times for performing anodic oxidation process to give the aluminum mesh (namely, the mesh member 20) containing the plurality of nanotubes.

The chemical reaction of the aluminum mesh in the anodic oxidation process is:

2Al³⁺+(3/2)O₂→Al₂O₃

After the chemical reaction, an AAO surface is formed on the aluminum mesh. The AAO surface is hydrophilic. In other words, by applying different operating voltages, the surface topography can be changed to achieve the purpose of high hydrophilicity.

According to the present embodiment, the mesh member 20 adopts 150-mesh, which translates to 0.106 mm mesh size. Accordingly, the mesh member 20 according to the present embodiment adopts meshes above 0.1 mm×0.1 mm. Nonetheless, the present invention is not limited to the present embodiment.

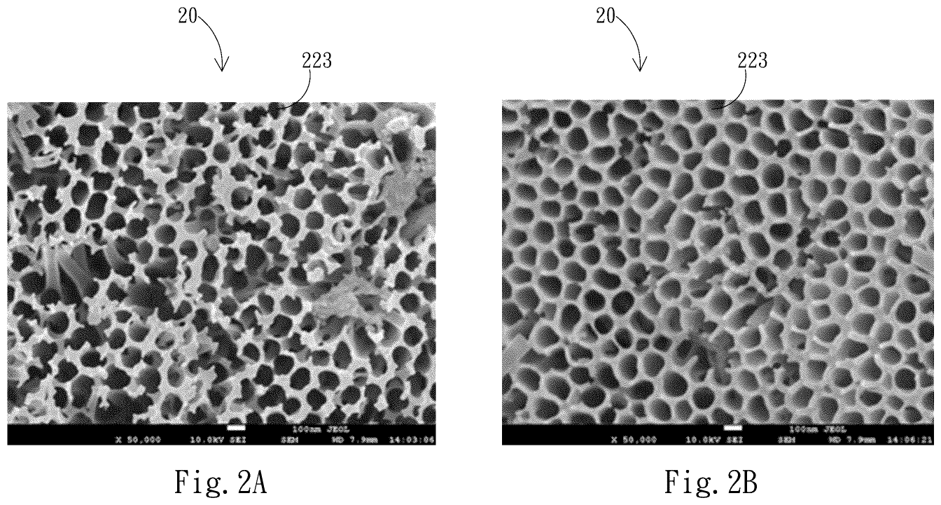

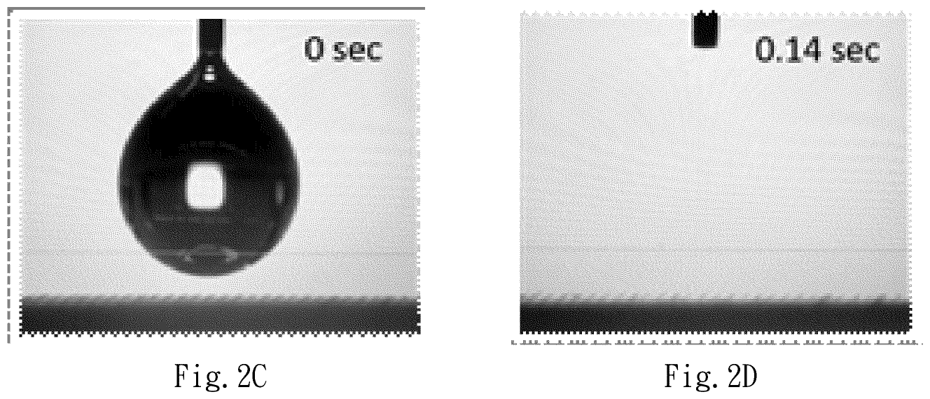

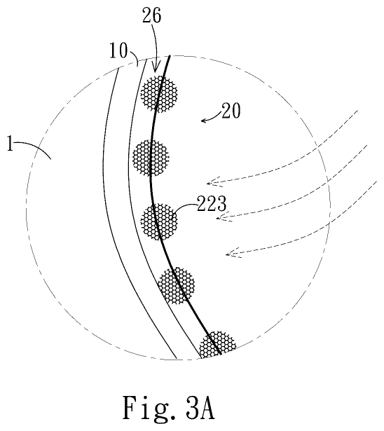

Please refer to FIG. 2A, which shows an SEM picture of the nanotubes according to an embodiment of the present invention, and to FIG. 2B, which shows an SEM of the nanotubes according to an embodiment of the present invention. As shown in the figures, the front side and back side of the structure of an anodic oxidation aluminum mesh are photographed by a thermal field Emission scanning electron microscope (FE-SEM). According to the figures, it is observed that a portion of the surface of the structure of the anodic oxidation aluminum mesh is removed by the electrolyte. A hydrophilic structure is formed on the surface of the anodic oxidation aluminum mesh (the mesh member 20) by the anodic process and thus forming the plurality of nanotubes on the frame of the mesh member 20. The diameters of the plurality of nanotubes are greater than 90 nm. Nonetheless, the present invention is not limited to the present embodiment. The surface of the mesh member 20 is a hydrophilic structure formed by the anodic process and hence facilitating absorbing the vapor in the air.

Moreover, the etching process can be adopted to modify the surface of the mesh member 20 for forming the hydrophilic structure on the frame of the mesh member 20. The modification process will be described in the following by using a copper mesh as the mesh member 20.

First, cut the 150-mesh (0.106 mm) copper mesh to the desired size. Immerse the copper mesh in the acetone, deionized water, alcohol, and deionized water sequentially and rinse by an ultrasonic vibrator for 15 minutes. Complete the above procedure for eliminating the oil and impurities on the surface of the copper mesh.

Next, prepare the solution for etching, The solution is a mixture of sodium hydroxide (NaOH) and ammonium persulfate ((NH₄)₂S₂O₈). Weigh the required chemicals using an electric balance. After preparing the solution, a magnetic stirrer is used to stir for 30 minutes for ensuring uniform mixing.

Clamp the rinsed and dried copper mesh using a fixture and immerse into the solution for etching. While etching, the temperature of the solution is maintained at 20° C. by using a double-layered beaker and a constant-temperature water bath. After etching for 90 minutes, the copper mesh is withdrawn. Use massive deionized water to rinse the surface of the copper mesh. Place the copper mesh in a petri dish for baking and drying. Then the mesh member 20 is prepared.

According to the present embodiment, the mesh member 20 adopts 150-mesh, which translates to 0.106 mm mesh size. Accordingly, the mesh member 20 according to the present embodiment adopts meshes above 0.1 mm×0.1 mm. Nonetheless, the present invention is not limited to the present embodiment.

The chemical reaction of the copper mesh in the etching process is:

Cu+(NH₄)₂S₂O₈+4OH⁻→Cu(OH)₂+2NH₃+2SO₄²⁻+2H₂O

The chemical reaction on the copper mesh form copper hydroxide (Cu(OH)₂), which owns the hydrophilic property with a blue color. By using the etching process, the chemical ingredients on the surface of the copper mesh is changed and the surface topography can be changed to achieve the purpose of high hydrophilicity.

To understand the absorption process of droplet on the copper mesh, the etching conditions for the mesh member 20 (the copper mesh) are 2M NaOH and 0.1M (NH₄)₂S₂O₈, etching for 90 minutes. Then the mesh member 20 is used for a droplet absorption experiment. Please refer to FIG. 2C, which shows a picture of droplet absorption according to an embodiment of the present invention, and to FIG. 2D, which shows a picture of droplet absorption according to an embodiment of the present invention. As shown in the figures, it takes only 0.14 seconds from dropping a droplet to complete absorption by the copper mesh. The rapid absorption proves superior hydrophilic effect of the mesh member 20.

According to the present embodiment, after modifying the surface of the mesh member 20, the hydrophilic structure will be formed on the surface of the mesh member 20. Thanks to the hydrophilic structure, the vapor in the air can be absorbed in the hydrophilic structure. Furthermore, after surface modification, the plurality of nanostructures will be formed on the frame of the mesh member 20. The plurality of nanostructures also facilitate the hydrophilic structure to absorb the vapor in the air by the capillary action.

That is to say, as shown in FIG. 1C, after thermal equilibrium between the air (the red dashed line in FIG. 1C) and the mesh member 20, the temperature of the air is lowered to a dew temperature so that the vapor in the air will condense on the mesh member 20.

When the vapor in the air condenses on the hydrophilic structure of the mesh member 20, there are two types of condensation:
1. The vapor in the air condenses on the second side 23 of the mesh member 20. The hydrophilic structure on the second side 23 absorbs the vapor and guides the vapor to the capillary structure layer 26. The vapor condenses to condensed water W within the capillary structure layer 26. Then the condensed water W will flow downward by a capillary action (not shown in the figure) or a capillary action combined with gravity P.
2. The vapor in the air condenses directly to the condensed water W in the capillary structure layer 26 formed between the temperature conduction device 10 and the hydrophilic structure of the mesh member 20. Then the condensed water W will flow downward by a capillary action (or capillary action combined with gravity P).

The capillary structure layer 26 described above will generate the so-called capillary action. The capillary action means that when a liquid is inside a thin tube or a porous object, forces are applied on the liquid including the adhesive force between the liquid and the object and the surface tensile force due to the cohesive force among the molecules of the liquid. Thereby, without external force, the liquid can flow into the thin tube or fine gaps. This phenomenon is an interface phenomenon of liquids.

Examples of the capillary action include:
1. Paper: Liquids are absorbed by the capillary action. The porous material enables absorption of the liquids by the paper.
2. Sponge: There exist many tiny porous structures (equivalent to capillaries, similar to the plurality of nanostructures 223 according to the present embodiment) in the sponge body. The porous structures enables the sponge to guide and absorb massive liquids.

In addition, according to the present embodiment, the dew temperature described above will vary according to different applications. Nonetheless, the dew temperatures will all be higher than the second temperature of the mesh member 20. For example, for a domestic dehumidifier, when the ambient humidity is 80% and the dry-bulb temperature is 25° C., the dew temperature is 23.1° C. In other words, when the ambient temperature is lowered to 23.1° C., there appears condensed water.

Moreover, in an extreme environment, for example, when the ambient humidity is above 90% and the dry-bulb temperature is above 35° C., the dew temperature is 31° C. It means that when the ambient temperature is lowered to 31° C., there appears condensed water. Thereby, the dew temperature will vary according to different environmental parameters.

When the air described above is lowered to the dew temperature, the vapor in the air will be converted to the condensed water. This is because under a fixed air pressure, the vapor contained in the air is saturated. At this temperature, the condensed water floating in the air is called the fog; the condensed water attached to a solid is called the dew. This is why the dew temperature is named.

The advantage of the present embodiment is that the cooling area and hydrophilicity can be increased by simply combining (or attaching) the temperature control device 1 and the temperature conduction device 10 (thermally conductive hydrophilic porous or mesh objects). By using the capillary structure layer 26 formed between the hydrophilic structure of the mesh member 20 and the temperature conduction device 20, the condensed water W can be absorbed toward the direction of the temperature conduction device 10. Then, by using the capillary action or the capillary action combined with gravity P, the condensed water W can be guided to the collection region. Hence, the vapor in the air can be collected effectively to a collection device. The dehumidification device and water collection structure according to the present embodiment can be applied to solid plastic or metal surfaces. The collected water can be applied to desalination, freshwater collection, wastewater recycling.

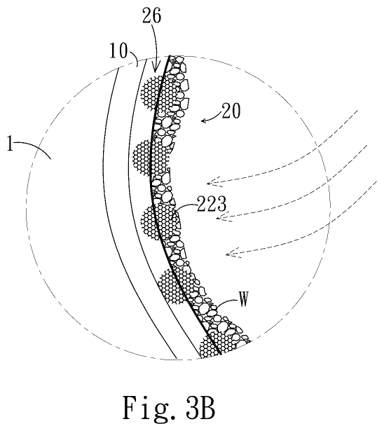

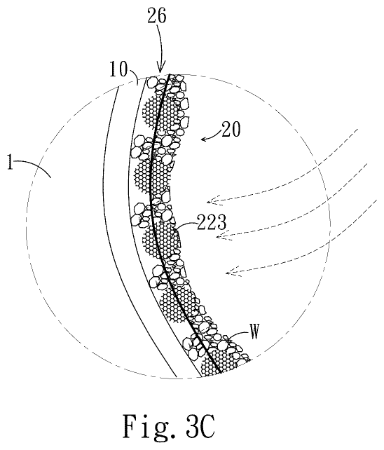

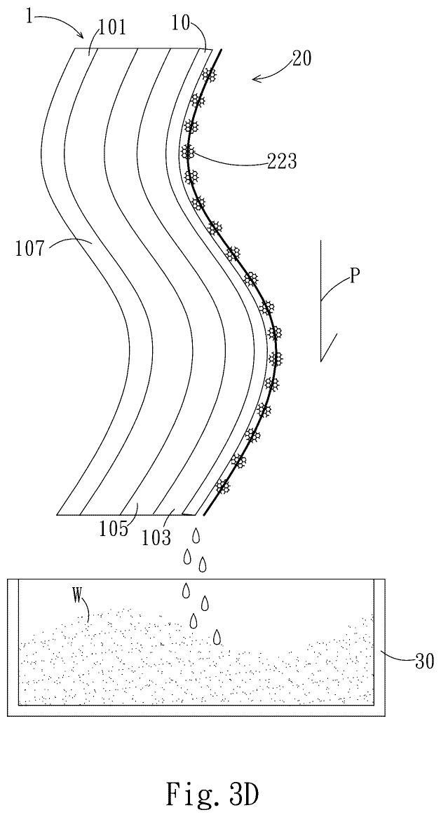

Next, in the following, the applications of the dehumidification and water collection structure according to the present embodiment will be described. Please refer to FIGS. 3A to 3D, which show schematic diagrams of the usage status of the dehumidification and water collection structure according to an embodiment of the present invention. The detailed absorption process of the vapor in the air by the hydrophilic structure on the modified surface of the mesh member 20 will be illustrated.

When a user attaches the dehumidification and water collection structure according to the present embodiment to one side of the cooling chip (the temperature control device 1) and lowers the temperature of the cooling chip to the first temperature, the temperature conduction device 10 will receive the first temperature and transfer the first temperature to the mesh member 20. Then the temperature of the mesh member 20 will be changed from the original temperature (the initial temperature to the first temperature.

When the temperature of the mesh member 20 is reduced to the first temperature, the side of the mesh member contacting the external environment will contact the air in the external environment. At this moment, the mesh member 20 will lower the temperature of the air gradually to the dew temperature. When the temperature of the air is reduced to the dew temperature, the vapor in the air will condense on the second side 23 of the mesh member 20. The hydrophilic structure of the mesh member 20 (or combining the plurality of nanostructures 223) will guide the condensed water W to enter the capillary structure layer 26. By using the capillary action or the capillary action combined with gravity P, the condensed water W will flow downward and to a water collection member 30 below the temperature conduction device 10 and the mesh member 20. The condensed water W in the water collection member 30 can be further applied to domestic or cleaning usage and thus achieving the effect of recycling and carbon reduction.

Alternatively, the vapor in the air can be condensed in the capillary structure layer 26 directly to form the condensed water W, Then, by using the capillary action or the capillary action combined with gravity P, the condensed water W can flow downward to the water collection member 30.

Next, to compare the water collection effects between the dehumidification and water collection structure according to the present embodiment and a unprocessed copper mesh, an experiment of water collection is performed as below:
Experimental group: The dehumidification and water collection structure according to the present embodiment (with the temperature conduction device 10 being a copper sheet and the mesh member 20 being a etched copper mesh).
Control group A: A general copper sheet combined with a unprocessed copper mesh.
Control group B: A general copper sheet.

The experimental result is shown in Table 1 below:

TABLE 1
Result of water collection

| | Experimental | Control group | Control group |
|---|---|---|---|
| | group | A | B |
| Collected water (g/h) | 0.59 | 0.358 | 0.171 |

In the experimental process for water collection, plenty of droplets are distributed on the copper sheer in the control group B. Unfortunately, the droplets will not tend to slide to form large water drops and fall into the water collection member 30.

In the control group A, since a general copper sheet combined with a unprocessed copper mesh is adopted, the cooling area can be increased. In addition, the capillary structure layer 26 will be formed between the copper sheet and the copper mesh. Thereby, the capillary action and the gravity P can act to guide the condensed water to the water collection member 30 and forming water films. In the experiment group, massive water films are formed.

In the experiment group, a general copper sheet and a etched copper mesh are adopted. By increasing the hydrophilicity, it is easier for the condensed water to be absorbed by the capillary structure layer 26 between the copper sheet and the copper mesh. Then, by using the capillary action and the gravity P, the condensed water can be guided to the water collection member 30 and forming massive water films.

According to the water collection result shown in Table 1, it is apparent that the water collection for the control group B is 0.171 g/h; the water collection for the control group A is 0.358 g/h; and the water collection for the experimental group is 0.59 g/h. The water collection for the experimental group is 3.45 times the water collection for the control group B and 1.64 times the water collection for the control group A. Thereby, the experimental group proves to have the most efficient water collection.

Furthermore, the dehumidification and water collection structure according to the present embodiment can be applied to cooling, desalination, freshwater collection, wastewater recycling. It complies with the requirements for cyclic economy and zero emission.

To sum up, the present invention provides a dehumidification and water collection structure disposed on one side of a temperature control device. By receiving the temperature of the temperature control device, the temperatures of a temperature conduction device and a mesh member can be lowered. When the mesh member contact the air, the temperature of the vapor in the air can be reduced below the dew temperature by using low temperature. Then the vapor in the air can be condensed in the hydrophilic structure on the mesh member rapidly. In addition, a capillary structure layer is used to collect the condensed water to a water collection member for subsequent applications.

What is claimed is:

1. A dehumidification and water collection structure, disposed on one side of a temperature control device, said temperature control device being used for converting a temperature to a first temperature, said temperature being greater than said first temperature, and comprising:
a temperature conduction device, covering one side of said temperature control device, and used for receiving said first temperature;
a mesh member, including a hydrophilic structure formed on the surface of said mesh member and used for condensing the vapor in the air, a first side of said mesh member disposed on the other side of said temperature conduction device, a capillary structure layer formed between said mesh member and said temperature conduction device, and said mesh member used for contacting said air;
where after thermal equilibrium between said air and said mesh member, an air temperature of the air is lowered to a dew temperature and condensing said vapor in said air on said mesh member.

2. The dehumidification and water collection structure of claim 1, wherein said temperature control device includes:
a hot end, used for generating said temperature, where said temperature is between 30° C. and 100° C.; and
a cold end, disposed on one side of said hot end, and said temperature conduction device covering said cold end;
where a heat dissipation device is disposed on the other side of said hot end and used for dissipating a heat source generated at said hot end.

3. The dehumidification and water collection structure of claim 2, wherein a semiconductor layer is further disposed between said hot end and said cold end for converting said temperature to said first temperature.

4. The dehumidification and water collection structure of claim 1, wherein said vapor is condensed on a second side of said mesh member; said vapor is absorbed by said hydrophilic structure on said second side and enters said capillary structure layer for condensing to form condensed water in said capillary structure layer; and then said condensed water flows downward by using capillary action or gravity.

5. The dehumidification and water collection structure of claim 1, wherein said vapor is condensed in said capillary structure layer to form condensed water in said capillary structure layer; and then said condensed water flows downward by using capillary action (or capillary action combined with gravity).

6. The dehumidification and water collection structure of claim 1, wherein said first temperature is between 4° C. and 25° C.

7. The dehumidification and water collection structure of claim 1, wherein said temperature conduction device adopts metals or nonmetals.

8. The dehumidification and water collection structure of claim 1, wherein said mesh member includes a thermal conduction coefficient.

9. The dehumidification and water collection structure of claim 8, wherein said thermal conduction coefficient is above 200 W/mK.

10. The dehumidification and water collection structure of claim 1, and further comprising a water collection member, disposed below said heat conduction member and said mesh member.

11. The dehumidification and water collection structure of claim 1, wherein said air temperature is greater than said second temperature.
